(19) United States
(12) Patent Application Publication
(10) Pub. No.: US 2008/0215415 A1
(43) Pub. Date: Sep. 4, 2008

(54) Mobile advertising

(76) Inventor: Paul Willms, Everett, WA (US)

Correspondence Address: WAGNER BLECHER LLP, 123 WESTRIDGE DRIVE, WATSONVILLE, CA, 95076, US

(21) Appl. No.: 11/999,816

(22) Filed: Dec. 6, 2007

Related U.S. Application Data
(60) Provisional application No. 60/874,016, filed on Dec. 7, 2006.

(51) Int. Cl. G06Q 30/00; G06F 17/00

(52) U.S. Cl. 705/10; 705/14

(57) ABSTRACT

A system for displaying a mobile advertisement is provided. The system includes a mobile carrier for transporting cargo in a geographical region. A control signal receiver is coupled with the mobile carrier, wherein the control signal receiver receives a control signal used to communicate data related to the mobile advertisement. In addition, a display panel is coupled with the mobile carrier, wherein the display panel displays the mobile advertisement in the geographical region based on the control signal.

### RELATED U.S. APPLICATION

This application claims priority to the copending provisional patent application Ser. No. 60/874,016, Attorney Docket Number ERUD-001.PRO, entitled “Utilizing a Mobile Container for Advertising,” with filing date Dec. 7, 2006, assigned to the assignee of the present application, and hereby incorporated by reference in its entirety.

### TECHNICAL FIELD

The technology relates to the field of mobile advertising applications.

### BACKGROUND

Advertising is a useful tool to communicating information to an audience. Advertisements may be used, for example, to communicate information related to a product of service offered by a vendor, or to sway the thoughts and opinions of an audience on such matters as religion, politics or social issues. An effective advertising campaign is oftentimes important for effectively communicating information. For example, a person may not know that a particular product or service is being offered by a vendor unit the person hears or views an advertisement communicating this information. Therefore, successful advertising can be an important tool during an information campaign.

### SUMMARY

This Summary is provided to introduce a selection of concepts that are further described below in the Detailed Description. This Summary is not intended to identify key or essential features of the claimed subject matter, nor is it intended to be used as an aid in determining the scope of the claimed subject matter.

A system for displaying a mobile advertisement is provided. The system includes a mobile carrier for transporting cargo in a geographical region. A control signal receiver is coupled with the mobile carrier, wherein the control signal receiver receives a control signal used to communicate data related to the mobile advertisement. In addition, a display panel is coupled with the mobile carrier, wherein the display panel displays the mobile advertisement in the geographical region based on the control signal.

### DESCRIPTION OF THE DRAWINGS

The accompanying drawings, which are incorporated in and form a part of this specification, illustrate embodiments of the technology for mobile advertising, and together with the description, serve to explain principles discussed below:

FIG. 1 is a block diagram of an exemplary display system used in accordance with an embodiment of the present technology.

FIG. 2 is a diagram of an exemplary display configuration used in accordance with an embodiment of the present technology.

FIG. 3 is a vertically-oriented cross-sectional plan view of an exemplary display panel configuration used in accordance with an embodiment of the present technology.

FIG. 4 is a diagram of an exemplary printing system used in accordance with an embodiment of the present technology.

FIG. 5 is a flowchart of a first exemplary method of targeted advertising used in accordance with an embodiment of the present technology.

FIG. 6 is a flowchart of a second exemplary method of targeted advertising used in accordance with an embodiment of the present technology.

FIG. 7 is a flowchart of an exemplary method of generating advertising revenue used in accordance with an embodiment of the present technology.

FIG. 8 is a block diagram of an exemplary computer system used in accordance with an embodiment of the present technology.

The drawings referred to in this description should be understood as not being drawn to scale except if specifically noted.

### DETAILED DESCRIPTION

Reference will now be made in detail to embodiments of the present technology for mobile advertising, examples of which are illustrated in the accompanying drawings. While the technology for mobile advertising will be described in conjunction with various embodiments, it will be understood that they are not intended to limit the present technology for mobile advertising to these embodiments. On the contrary, the presented technology for mobile advertising is intended to cover alternatives, modifications and equivalents, which may be included within the spirit and scope of the various embodiments as defined by the appended claims.

Furthermore, in the following detailed description, numerous specific details are set forth in order to provide a thorough understanding of the present technology for mobile advertising. However, the present technology for mobile advertising may be practiced without these specific details. In other instances, well known methods, procedures, components, and circuits have not been described in detail so as not to unnecessarily obscure aspects of the presented embodiments.

### Overview

Although advertising can be a powerful tool in an information campaign, the information in an advertisement may not be able to efficiently reach a significant cross-section of a population based on a static nature of the advertisement. An embodiment provides a method of mobile advertising, wherein an advertisement is moved through a geographic region in order to increase the number of people who are privy to the content of the advertisement. Moreover, a revenue stream is generated by providing the advertisement in a targeted geographical region based on a human population in the region.

In one embodiment, a movement or route of an advertisement through a geographic region is coordinated so as to maximize a viewability of the advertisement in the region. For example, a mobile advertisement travels along a first route, and the viewability associated with this route is evaluated based on human traffic along the route. Moreover, the viewability associated with a second route is determined to be greater than the viewability of the first route. Therefore, the mobile advertisement is re-routed to the second route such that the viewability of the advertisement is increased.

Furthermore, pursuant to an embodiment, an advertisement is presented in a geographical region based on a projected effectiveness of the advertisement on a population in the region. Various criteria are taken into consideration so as to select an advertisement having a context that is appealing to a large cross-section of the population. In this manner, an advertising campaign in a geographic region is dynamically tailored so as to maximize its effectiveness in the region.

### Mobile Advertising

Although different methods may be employed for generating a mobile advertisement and moving the advertisement through a region of interest, various exemplary systems are discussed herein. However, the spirit and scope of the present technology is not limited to these exemplary systems, which are presented for purposes of illustration.

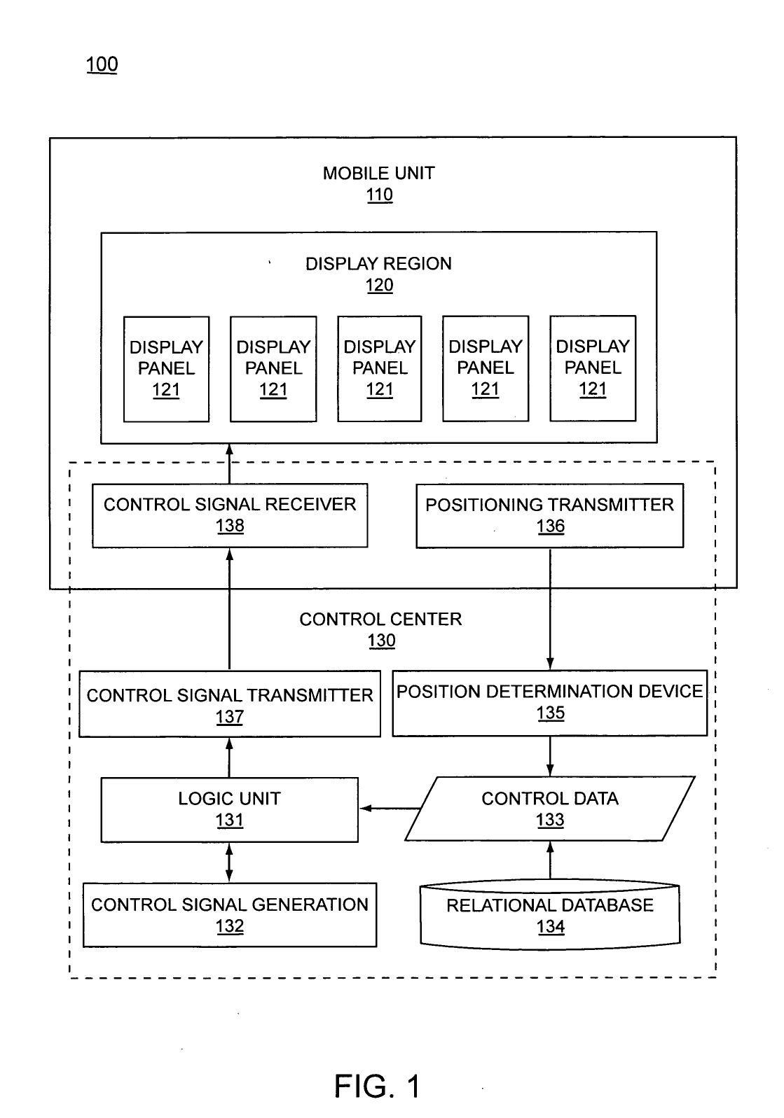

With reference now to FIG. 1, an exemplary display system 100 in accordance with an embodiment is shown. Display system 100 includes a mobile unit 110 having a display region 120 for presenting an advertisement in a targeted geographical region (TGR). In particular, the advertisement is presented using display region 120 such that the advertisement is viewable to a portion of a human population of the TGR.

In an embodiment, display system 100 is configured to increase the viewability of an advertisement in the TGR by causing the advertisement to become mobile. In particular, the advertisement is displayed in display region 120, and mobile unit 110 travels through the TGR such that the advertisement is viewable to a greater portion of the human population of the TGR. Consider the example where mobile unit 110 travels through, or adjacent to, a section of the TGR having a certain amount of human traffic. By moving the advertisement displayed in display region 120 relative to this human traffic, the advertisement is viewable to a greater portion of this human traffic compared to the scenario wherein the advertisement remains stationary.

In an alternative embodiment, however, mobile unit 110 travels to a location within the TGR wherein the human traffic is substantially mobile. Mobile unit 110 remains substantially stationary with respect to the mobile human traffic such that the human traffic travels past mobile unit 110. Consider the example where mobile unit 110 is placed in a position substantially adjacent to a road within the TGR such that display region 120 is viewable from the road. Drivers and passengers of vehicles that travel along the road view the advertisement displayed in display region 120 as the vehicles pass mobile unit 110. In this manner, display system 100 utilizes the natural flow of the human traffic in the TGR to increase the viewability of an advertisement in display region 120.

The foregoing notwithstanding, an embodiment provides that mobile unit 110 is a mobile carrier used for transporting cargo. For example, the mobile carrier is employed for the purpose of transporting goods within a geographical region. Owners of the transported goods pay a fee for having their goods transported from a source location to a final destination. However, an economic overhead is contributed to the transportation of these goods. In particular, overhead costs associated with, for example, fuel, tolls and the costs of repairs to the mobile carrier are endured by the employer of the mobile carrier. However, the geographical region in which the mobile carrier travels is identified as being a region of interest to an entity seeking to advertise a product or service that the entity is willing to vend to the public. In response, an advertisement is presented in display region 120, wherein the advertisement is used to advertise the entity's product or service to a population in the geographical region. In return for this advertising service, the entity pays the employer of the mobile carrier an advertising fee, which the employer may then use to offset the costs associated with transporting the mobile carrier within the geographical region.

With reference still to FIG. 1, display region 120 includes multiple display panels 121 used to display advertising information in display region 120. Different panels from among display panels 121 may be used to display the same or different portions of the same advertisement. However, in one embodiment, two or more panels from among display panels are display different advertisements, wherein these different advertisements are associated with the same or different entities.

Pursuant to an embodiment, display panels 121 display information based on a control signal. Consider the example where display panels 121 are electronic display panels, such as cathode ray tube (CRT), plasma, liquid crystal display (LCD) or light emitting diode (LED) screens. The control signal is an electronic signal sent to the electronic panels to communicate which advertisement each panel is to display. Moreover, the electronic panels are configured to update the displayed advertisements in response to a change in the received control signal. In this manner, the advertising presented in display region 120 may be dynamically altered over time.

Moreover, an embodiment provides that the control signal communicates the advertisement to a display panel by providing an electronic representation of the advertisement. For example, an electronic representation of the advertisement is generated, wherein the electronic representation includes digital bits of data. An electronic display within display region 120 receives this digital data, by means of the control signal, and converts this data into a visual representation of the advertisement that is viewable to a human population in a TGR.

In one embodiment, however, display panels 121 have printable surfaces, and the control signal is sent to a printing system configured to print advertisements on these printable surfaces. Consider the example where a printing system includes one or more printer heads used to print information on display panels 121. The printing system receives the control signal, which communicates the data that is to be printed on the display panels 121. In response to the substance of this control signal, the printing system moves the print heads relative to display panels 121 such that the print heads are able to print information at different locations on display panels 121. Moreover, printing system simultaneously communicates that information that is to be printed at each location on each of display panels 121 based on the information communicated by the control signal.

With reference still to FIG. 1, display system 100 further includes a control center 130 that utilizes a logic unit 131 to generate the control signal used to control the advertising displayed in display region 120. In particular, logic unit 131 performs a control signal generation process 132 utilizing a set of control data 133, and generates the control signal based on the substance of control data 133. Moreover, in one embodiment, control data 133 is stored in a relational database 134. Control data 133 is transmitted to logic unit 131 from relational database 134 such that logic unit 131 is able to consider control data 133 during control signal generation process 132.

In an embodiment, control signal generation process 132 includes the execution of a control algorithm configured to generate a dynamic output based on the substance of control data 133. For example, control center 130 includes an intelligence engine that includes the control algorithm and logic unit 131. The intelligence engine considers various factors associated with a region of interest, and identifies an advertisement that is well-suited to the region based on a dynamic analysis of these factors. Moreover, an embodiment provides that the intelligence engine is an artificial intelligence (AI) engine, wherein the AI engine is capable of assigning different weighted values to various control factors so as to decide, based on a specific scenario, how important each factor is to the overall advertisement selection process.

In an embodiment, control data 133 includes data pertaining to a geographical area of interest. However, pursuant to one implementation, control data 133 includes data related to one or more advertisements of interest. For example, control data 133 is electronic data accessed in relational database 134, wherein control data 133 digitally communicates information that may be used by an optical display device to create a visual representation of an advertisement. This data is then included in the control signal generated by logic unit 131 such that the information that is ultimately displayed by display panels 121 originates in relational database 134.

Moreover, data stored in relational database 134 may be updated or changed over time. Consider the example where relational database 134 stores information pertaining to both an area of interest as well potential advertisements that may be presented in display region 120. As data relating to the geographic region, such as consumer spending habits, or relating to an advertisement, such as the advertised price of a good or service, changes over time, the data may be updated in relational database 134. In this manner, an effectiveness of the advertising that is ultimately displayed in display region 120 is maximized by maintaining relational database 134 with current information on a regular basis.

In an embodiment, control data 133 includes data relating to a position of mobile unit 110 in a geographical region. With reference still to FIG. 1, a position determination device 135 is used to determine a position of mobile unit 110. Position determination device 135 determines position coordinates associated with mobile unit 110, and these position coordinates are forwarded to logic unit 131 such that the position of mobile unit 110 may be taken into account during control signal generation process 132.

In one embodiment, a positioning transmitter 136 is operatively coupled with mobile unit 110, wherein positioning transmitter 136 transmits a positioning signal to position determination device 135. Position determination device 135 utilizes the received positioning signal to determine a present location of mobile unit 110 in a TGR. Moreover, pursuant to one embodiment, position determination device 135 obtains real-time position coordinates of mobile unit 110 and wirelessly transmits these real-time position coordinates to a tracking station. The tracking station then utilizes these coordinates to track a movement of mobile unit 110 through a TGR over time.

With reference still to FIG. 1, logic unit 131 routes the generated control signal to a control signal transmitter 137, which transmits the control signal to a control signal receiver 138. Therefore, control signal receiver 138 is implemented to receive the control signal subsequent to a successful transmission of the signal. In one embodiment, control signal receiver 138 is also utilized in providing information in the control signal to display panels 121 located in display region 120. For example, display panels are electronic display panels that convert electronic data into a visual representation of the data. Control signal receiver 138 receives the control signal in a first format, and then converts the signal into a second format that is recognizable by display panels 121. The converted signal is then routed to display panels 121 such that the information communicated by the control signal is displayed in display region 120.

In one embodiment, the control signal is an analogue signal, and control signal receiver 138 implements an analogue-to-digital converter (ADC) to convert the analogue signal into a digital signal. In an alternative implementation, control signal receiver 138 uses a digital-to-analogue converter (ADC). Consider the example where a printing system is utilized to print advertisements on surfaces of display panels 121. The printing system utilizes an analogue input to move a number of printing heads relative to display panels 121. The control signal is sent to control signal receiver 138 in a digital format, so as to minimize the effects of signal distortion on the propagated signal. Control signal receiver 138 receives the digital control signal and converts it into an analogue format, which is then routed to the printing system.

Moreover, in one embodiment, control signal transmitter 137 and control signal receiver 138 are wireless transceivers for wirelessly transmitting and receiving the control signal. In an example, logic unit 131 is located remotely from mobile unit 110. Logic unit 131 performs control signal generation process 132, and control signal transmitter 137 wirelessly transmits the generated control signal to mobile unit 110. Control signal receiver 138 wirelessly receives the control signal, and the content displayed by display panels 121 is updated based on the substance of the control signal.

### Exemplary Decision Criteria

With reference again to FIG. 1, an embodiment provides that logic unit 131 includes a computer microprocessor that processes digital bits of data based on a processing algorithm. Further, logic unit 131 executes this algorithm during control signal generation process 132, wherein the algorithm is designed to yield the control signal that is ultimately used to control the advertising in display region 120 based on a set of input data. In particular, logic unit acquires control data 133, such as from relational database 134, and this control data 133 includes the set of input data used to yield the output of the implemented control algorithm.

In an embodiment, the set of input data communicated as control data 133 includes one or more decision criteria used by the control algorithm to generate a substance of the control signal. For purposes of illustration, various exemplary types of decision criteria are discussed herein. However, the spirit and scope of the present technology are not limited to the use of such exemplary criteria. Indeed, other factors and criteria may also be utilized.

### Country of Residence

In an embodiment, the country or countries in which a TGR is located is taken into account by the control algorithm. For example, different countries have different traditions, consumer statistics, spoken languages, etc. Assessing these different factors allows the control algorithm to select a specific advertisement that is appropriate to the geographic region based on the type of population in such region. Moreover, this information further allows the algorithm to select an advertisement that will be relatively effective in the region based on the tastes and customs of the people in the region. In this manner, the advertising is targeted so as to increase the effectiveness of the advertising in the TGR.

To further illustrate, an example provides that a country of residence of a TGR is an Islamic country located in Asia, wherein approximately 69% of the human inhabitants of the country are Muslim. This information is contained in relational database 134, as well as data disclosing that many Muslims believe advertisements showing female models wearing bikinis to be offensive to their religion. These factors are received by logic unit 131, by means of control data 133. Implementation of the control algorithm during control signal generation process 132 yields a result pursuant to which advertisements that display female models wearing bikinis are disqualified as potential candidates for advertisements that are to be shown in the TGR. Alternatively, if the TGR is Oceania, wherein approximately 0.025% of the population is Muslim, advertisements displaying female models wearing bikinis will not be disqualified as advertisement possibilities.

In one embodiment, the control algorithm is further configured to estimate a potential revenue stream associated with providing a particular advertisement in a specific TGR, or in a specific portion of a TGR. For example, different populations are characterized as having different spending habits. The advertisements displayed in a specific region are therefore tailored with respect to the spending habits of the inhabitants of the region so as to further increase the advertisements' marketing effectiveness.

### Language

In an embodiment, the languages used by the human inhabitants of the TGR are taken into account by the control algorithm. Consider the example where an industrial shipping container is used to transport cargo to different geographic regions, and the shipping container is utilized for displaying advertisements to the human populations of these regions while the container is being transported. The spoken languages associated with each region are taken into account when determining which advertisements are appropriate for the region. A specific advertisement to be displayed from the shipping container is then selected depending on a destination of the shipping container within a TGR.

To further illustrate, China is characterized as having a high level of internal linguistic diversity. Regional variation between different linguistic variants or dialects is relatively significant. Indeed, many variants of spoken Chinese are different enough to be mutually incomprehensible. In fact, there are between six and twelve main regional groups of Chinese, depending on classification scheme. To illustrate, approximately 800 million people speak Mandarin, while the number of people who speak Wu and Cantonese is 90 million and 80 million, respectively. Therefore, an implementation takes these regional linguistic differences into account during the process of selecting an appropriate advertisement for the region. For example, advertisements presented in a region wherein the spoken language is predominantly Mandarin will include terms and slogans presented in the Mandarin language rather than in Wu or Cantonese.

In an embodiment, an advertisement is presented audibly. The audible content of an advertisement is scrutinized so as to determine whether the content is linguistically compliant with a spoken language in the TGR, such as the predominantly spoken language. If the content is not linguistically compliant, the content is translated into a linguistically compliant format, or the advertisement is disqualified as an advertisement possibility while the content of other potential advertisements is linguistically scrutinized.

With reference again to FIG. 1, in one embodiment, the advertisements displayed in display region 120 are changed when mobile unit 110 travels from a first region to a second region based on linguistic differences between the two regions. This enables dynamic updating of the displayed advertisements in response to various linguistic criteria in order to increase an effectiveness of the advertisements in a TGR.

### Demographics

In an embodiment, the control algorithm is configured to take into account the demographics or population characteristics of a TGR, such as when estimating a projected revenue stream associated with presenting a specific advertisement in the TGR. For example, demographics may be related to various factors associated with members of a population of a TGR, such as race, age, income, mobility (such as in terms of travel time to work or number of available vehicles), educational attainment, home ownership, employment status, or location. Moreover, distributions of values within a demographic variable, and across households, may be factors of interest, as well as temporal trends exhibited by a portion of the population.

In an embodiment, populations are grouped into categories based on demographic variables. Consider the example where members of a population are grouped according to such factors as age, sex, gender, race/ethnicity, location of residence, socioeconomic status (SES), religion, marital status, ownership (e.g., home, car, pet, etc.), language, fertility, mortality, or migration. Such groupings allow an ad provider to target either the general population, or a subset thereof.

For example, if a majority of members of a specific regional population are primarily Caucasian male homeowners between the ages of 40 and 50, an advertisement displayed in display region 120 will be tailored according to the marketing trends associated with these variables. However, an ad provider may also wish to target children of these homeowners, even though these children constitute a population minority within the TGR. Different advertisements are displayed in display region 120, wherein the different advertisements appeal to the adult homeowners or their children. This allows advertising displayed by mobile unit 110 in a TGR to be diversified such that the aggregated advertising appeals to a greater range of the population based on various demographic factors. In this manner, the overall effectiveness of the advertising is increased such that a greater amount of advertising revenue may be generated.

### Local Variations

In an embodiment, the control algorithm takes into account various local variations associated with a TGR, such as when estimating a projected revenue stream associated with presenting a specific advertisement in the TGR.

Consider the example where mobile unit 110 is a shipping container used to transport goods within a specific country. The algorithm considers different weather conditions in different parts of a country, as well as the season of the year when the shipping container will be present in a particular part of the country, and advertisements are selected that will be displayed in display region 120 based on these factors. For example, an advertisement used to advertise summer swim wear is not displayed in display region 120 when mobile unit 110 is traveling through a relatively cold region during a winter month. Instead, a different advertisement is displayed that is more appropriate for the weather and seasonal conditions, such as an advertisement used to advertise a sale on winter jackets at a local department store.

In one embodiment, a method of dynamic advertising is implemented, wherein an advertisement is presented based on a change in temperature. Consider the example where one or more thermal sensors are installed on a mobile unit 110. When mobile unit 110 travels through a geographical region that is relatively warm, these thermal sensors determine the ambient temperature and this information is provided to logic unit 131. Furthermore, the implemented control algorithm is configured to take this thermal data into consideration during control signal generation process 132 so that an advertisement is selected that has a context that is appealing based on the detected warm weather. For example, an advertisement is selected that advertises a cold beverage. However, when mobile unit 110 crosses over into a geographic area that is relatively cold, previous advertisement is replaced with a new advertisement having a context that is appealing based on the detected cold weather, such as an advertisement that advertises a warm beverage.

### Traffic Patterns

In an embodiment, the control algorithm takes into account traffic patterns associated with a TGR, such as when estimating a projected revenue stream associated with presenting a specific advertisement in the TGR.

In an embodiment, traffic patterns affect the effectiveness of an advertisement. For example, vehicular traffic in a TGR is organized pursuant to roads that include multiple travel lanes wherein vehicles move in a particular direction. Various junctions, intersections, interchanges, traffic signals and signs are also used to coordinate the traffic. To illustrate, a vehicle traveling along a road stops at an intersection in response to a traffic signal. At this point, the operator of the vehicle takes a moment to view the surrounding panorama while yielding the vehicular right-of-way to vehicles traveling in a different lane of traffic. At this point, an opportunity is presented to acquire the attention of the operator of the vehicle while the operator continues to wait to begin traveling again.

Pursuant to an embodiment, such traffic patterns are taken into account when determining a route that mobile unit 110 is to follow through the TGR so as to increase an overall viewability of advertisements presented in display region 120. For example, a route of mobile unit 110 is selected so as to be adjacent to a congested intersection during a time of the day when traffic is at its peak. If follows that a greater number of people will be able to see the advertisement displayed using mobile unit 110. Moreover, the effectiveness of the advertising is consequently increased, since an objective of a successful advertising campaign is to increase the number of persons who are privy to the content of the advertising.

In an embodiment, data related to these traffic patterns is stored in relational database 134. Logic unit 131 acquires this traffic related data when receiving control data 133, and this traffic related data is utilized during control signal generation process 132. However, in one embodiment, simulations of organized traffic are used to generate the traffic related data by modeling or estimating various traffic patterns associated with a TGR. Such simulations may involve, for example queuing theory as well as stochastic processes and equations of mathematical physics as applied to traffic flow.

### Consumer Statistics

In an embodiment, the control algorithm takes into account consumer statistics associated with a TGR, such as when estimating a projected revenue stream associated with presenting a specific advertisement in the TGR. For example, a government institution of a country in which the TGR is located gathers statistical information relevant to the disposable income of various segments of the population. Such statistical data includes economic growth, consumer pricing, income of persons and households, population count and unemployment. Moreover, these consumer statistics are acquired from the government institution and used to select advertisements that will appeal to a greater cross-section of the population based on the projected disposable income of the various segments.

### Weighted Values

In an embodiment, a set of weighted values are utilized to determine whether to move mobile unit 110 in a particular geographical region, and which advertisements are to be presented in display region 120. Consider the example where mobile unit is a shipping container having a specified load capacity, wherein the amount of cargo that the shipping container can transport at a specific point in time is based on this load capacity. The weighted value of the container's load is evaluated with respect to the weighted value of a potential advertisement that may be displayed using the container, such that transportation of the load must generate at least a first level of revenue with respect to a second level of revenue associated with the potential advertisement such that a particular profit margin may be realized.

In one example, if the weighted value of the container's load with respect to the weighted value of the potential advertisement do not prospectively yield a requisite profit margin, the size or type of the load is adjusted, or the potential value of another advertisement is considered. However, if changing the load or advertisement still does not allow profit expectations to be met, the container remains stationary.

After the various decision criteria have been evaluated, an embodiment provides that logic unit 131 pre-programs a route of a mobile unit 110 as a de-fault option. The pre-programmed route is selected based on various control factors, such as demographics, local variations, traffic patterns, and consumer statistics associated with the TGR. The essence of the process of route-pre-programming is to minimize negative factors and to emphasize positive factors that are relevant to the generation of revenue caused by an exposure of a targeted population to the selected advertisement. Thus, demographics of the TGR are considered to select the best advertisement so as to maximize the advertising revenue generated based on an increased viewability of the advertisement.

In one embodiment, the route is pre-programmed in such a way as to minimize the effect of local variations of the TGR within the route. In addition, the timing of the pre-programmed route is coordinated so as to minimize the delaying effect of the traffic. Moreover, consumer statistics of the TGR are examined to pre-program a route that would target the population with the largest disposable income which is consistent with zoning requirements.

### Positional Tracking

With reference still to FIG. 1, display system 100 includes position determination device 135, which is configured to determine a position of mobile unit in a geographical area. Position determination device 135 may include, for example, a global positioning system (GPS) receiver, a global orbiting navigation satellite system (GLONASS) receiver, a GALILEO receiver, a global navigational satellite system (GNSS) receiver, or a pseudolite receiver.

GPS often refers to a system of satellite signal transmitters that transmits information from which an observer's present location and/or the time of observation can be determined. Similarly, GLONASS is a system of satellites that is presently maintained by the Russian Republic. Moreover, the European Union has announced its intention to develop an independent satellite navigation system known as GALILEO. An embodiment utilizes one or each of these satellite systems for geo-location applications when tracking a present location of mobile unit 110.

In an alternative embodiment, a ground based radio positioning system is implemented, such as a system that utilizes one or more pseudolite transmitters. For example, position determination device 135 includes a pseudolite receiver. The pseudolite comprises a ground based radio positioning system that operates using a radio frequency, such as a GPS frequencies or a frequency within the industrial scientific medical (ISM) unlicensed operation band. Examples of such frequencies include, but are not limited to the 900 MHz, 2.4 GHz, or 5.8 GHz ISM bands, or a radio location band such as the 9.5-10 GHz band. Moreover, an embodiment utilizes pseudolites to enhance the GPS by providing increased accuracy, integrity, and availability.

Therefore, various embodiments provide for the use of one or more wireless transceivers. In one embodiment, a wireless transceiver is implemented that utilizes a communication link selected from the group consisting of a cellular link, a radio link, a wireless satellite communication link or a wireless Internet link. For example, positioning transmitter 136 is configured to transmit data communicating a present position of mobile unit, and this data is stored in a database connected to the World Wide Web. In this manner, the positional data may be tracked over the Internet.

### Exemplary Display Configurations

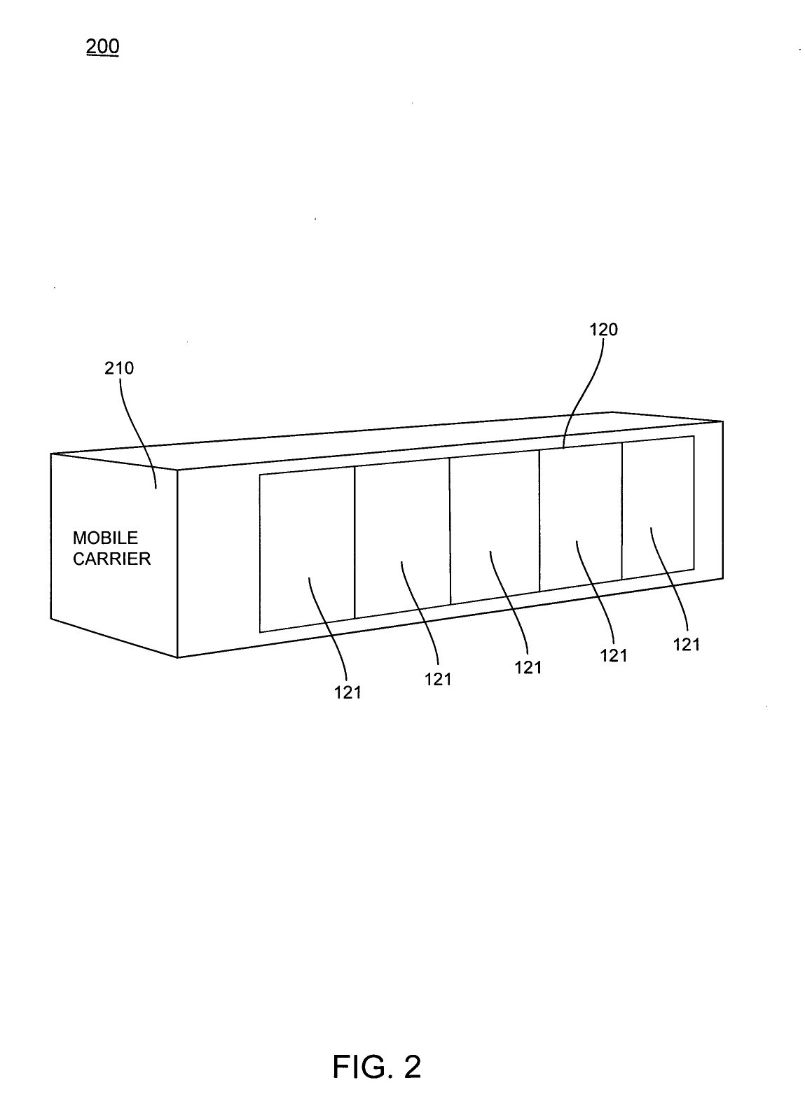

With reference now to FIG. 2, an exemplary display configuration 200 in accordance with an embodiment is shown. A mobile carrier 210 is used to transporting goods within a geographical region. A portion of a side of mobile carrier 210 is used as display region 120, which includes a set of display panels 121. Moreover, the geographical region in which mobile carrier 210 travels is identified as being a region of interest to an entity seeking to advertise a product or service, and as a result, the entity acquires the use of one or more of display panels 121 to advertise such product or service on a viewable portion of mobile carrier 210 while mobile carrier 210 is in transit through the geographical region.

In an embodiment, each of display panels 121 is used to display a different advertisement. Consider the example where different advertisements are displayed in display region 120 using display panels 121, wherein each advertisement is associated with a different client. Each client pays a fee for the use of a single display panel among display panels 121, and the generated fees are used to accumulate advertising revenue.

In an alternative embodiment, however, two or more panels from among display panels 121 are used to display different portions of the same advertisement. For example, display panels 121 are cascaded in a horizontal configuration within display region 120, and each of display panels 121 is used to display a different portion of an advertisement. The aggregated portions of the advertisement in display region 120 causes the advertisement to be viewable from mobile unit 110, while the size of the advertisement in display region 120 is increased compared to the scenario wherein the advertisement is displayed solely within a single panel from among display panels 121.

In one implementation, a second container mobile carrier is located adjacent to mobile carrier 210 so as to create a larger advertising space. Consider the example where a second mobile carrier is stacked above or below mobile carrier 210 such that the display region of the second mobile carrier substantially aligns with display region 120 pursuant to a vertical alignment. A portion of an advertisement is displayed in display region 120, while another portion of the same advertisement is displayed in the display region of the second mobile carrier. In this manner, the size of the advertisement is increased by utilizing multiple mobile carriers.

Indeed, many different mobile carriers are simultaneously transported across a geographical region, such as on a train. These mobile carriers are positioned such that information displayed in the advertising display regions associated with the different mobile carrier units may be optically aggregated by a viewer. Moreover, each display region is used to display a different portion of a single advertisement. In this manner, an even larger display region is created such that the advertisement is viewable by the human eye across a longer distance. This implementation aids in increasing overall viewability of an advertisement.

In an embodiment, a method of angular advertising is implemented, wherein different images are displayed based on an angle at which a viewer is viewing an advertisement. For example, two or more images are viewable from a single panel from among display panels 121 using a tubular display system. Multiple tubes are cascaded across a display panel, wherein each tube is configured to display a different portion of an image based on a viewing angle of a viewer. The aggregated effect of these different portions causes the viewer to perceive an entire image at once. Moreover, when the viewer moves to a different location having a different viewing angle with respect to the display panel, the tubes display portions of a different image to the viewer.

Systems other than tubular displays may also be implemented during the angular advertising process. For example, a display may include a holographic image of a first advertisement, wherein the holographic image is configured to display a second advertisement when the viewing angle of the viewer with respect to the holographic image changes.

With reference again to FIG. 2, various methods of mounting display panels 121 may be implemented. In an embodiment, an adhesive substance is used to attach display panels 121 to mobile carrier 210. Pursuant to one example, however, a mechanical coupling method is used to mount display panels 121 on mobile carrier 210. Consider the example where display panels 121 include a number of holes configured to align with holes in a side of mobile carrier 210. This hole alignment is used to bolt display panels 121 to mobile carrier 210.

In an alternative embodiment, a magnetic method is implemented so as to magnetically couple display panels 121 with mobile carrier 210. For example, mobile carrier 210 is made of a metal or steal alloy, and multiple magnets are strategically attached to various point on the back sides of display panels 121 such that these back sides are attracted to a side of mobile carrier 210. In one embodiment, however, display panels 121 are themselves made of a magnetic material such that display panels are magnetized.

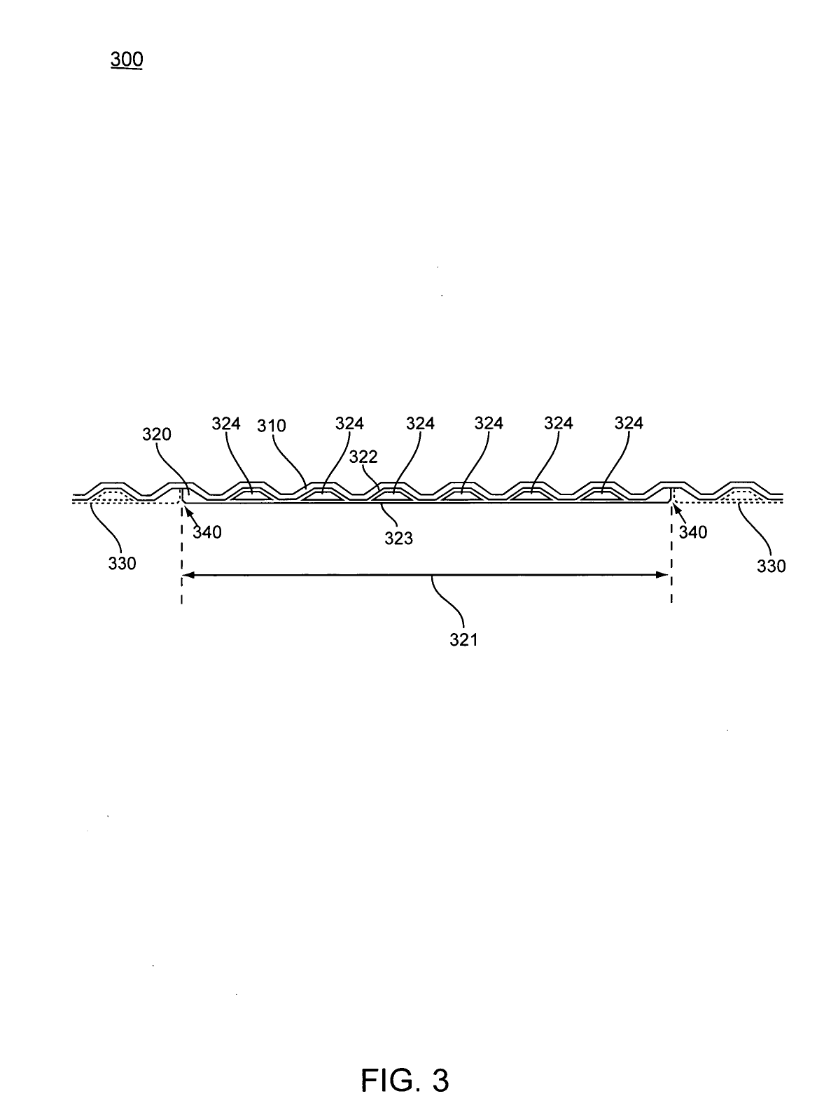

With reference now to FIG. 3, an exemplary display panel configuration 300 in accordance with an embodiment is shown. A portion of mobile carrier 210 includes a corrugated side 310. For purposes of illustration, FIG. 3 shows a vertically-oriented cross-sectional plan view of corrugated side 310. A corrugation-compliant modular display panel 320 having horizontal width 321 is coupled with corrugated side 310. In particular, corrugation-compliant modular display panel 320 has a corrugated surface 322 configured to couple with corrugated side 310 such that physical protrusions of corrugated side 310 fit between physical protrusions of corrugated surface 322. In this manner, a contract area between corrugated side 310 and corrugation-compliant modular display panel 320 is maximized.

In an embodiment, a transportation of mobile carrier 210 causes mobile carrier to experience various external forces, and these forces cause corrugated side 310 to move or vibrate. However, the corrugated coupling of corrugated side 310 and corrugated surface 322 prevents corrugation-compliant modular display panel 320 from moving in a horizontal direction relative to mobile carrier 210. In this manner, the position of corrugation-compliant modular display panel 320 relative to corrugated side 310 remains relatively static when external forces act upon mobile carrier 210.

With reference still to FIG. 3, corrugation-compliant modular display panel 320 further includes a display surface 323 that is substantially flat. Therefore, while corrugated surface 322 is used to efficiently couple corrugation-compliant modular display panel 320 with corrugated side 310, display surface 323, located opposite corrugated surface 322, is utilized as a viewable region for displaying an advertisement from mobile carrier 210. In this manner, a surface of corrugated side 310 is flattened such that an advertisement may be more easily, efficiently and effectively displayed.

For example, printing an advertisement a surface of corrugated side 310 causes the advertisement to be distorted due to the physical protrusions of corrugated side 310. However, mounting corrugation-compliant modular display panel 320 on corrugated side 310 creates a flat surface upon which an advertisement may be effectively displayed without such physical distortion.

In an embodiment, hollow regions 324 are located between corrugated surface 322 and display surface 323. These hollow regions 324 cause a weight associated with corrugation-compliant modular display panel 320 to be decreased, which in turn enables a transportation weight associated with mobile carrier 210 to be decreased. Consider the example where the energy associated with moving an object is a function of the weight of the object to be moved. A transportation weight associated with mobile carrier 210 includes the weight of mobile carrier 210, the weight of any cargo transported within mobile carrier 210, as well as the weight of corrugation-compliant modular display panel 320. Decreasing the weight of corrugation-compliant modular display panel 320 aids in minimizing the total transportation weight, which enables mobile carrier 210 to be more easily transported, since a smaller degree of energy will be expended when physically moving mobile carrier 210 from a source location to a destination.

With reference still to FIG. 3, display panel configuration 300 further includes adjacent display panels 330 located next to corrugation-compliant modular display panel 320. Horizontal width 321 is configured to be a function of the physical protrusions and indentations of corrugated side 310 such that a horizontal alignment between corrugation-compliant modular display panel 320 and adjacent display panels 330 is achieved at joints 340.

### Exemplary Printing Configurations

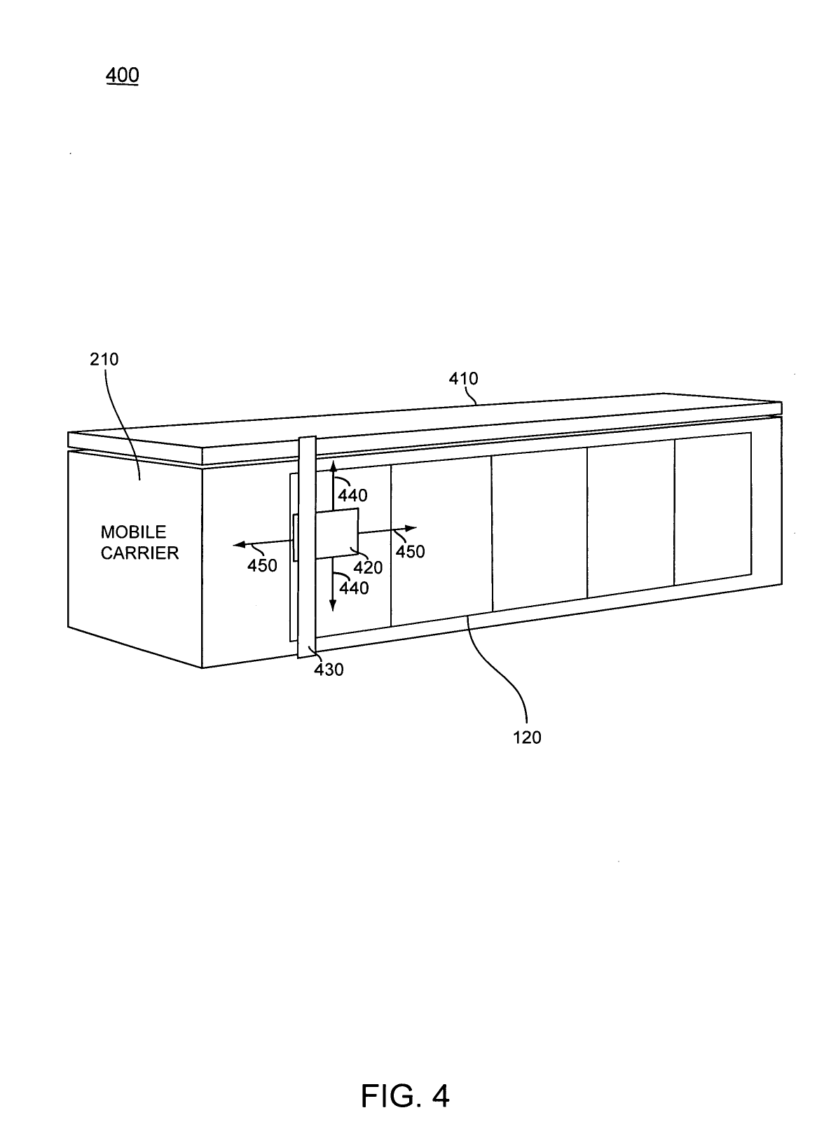

With reference now to FIG. 4, an exemplary printing system 400 in accordance with an embodiment is shown. A printer structure 410 is located adjacent to mobile carrier 210. Printer structure 410 utilizes at least one print head 420 to print information on one or more printable surfaces in display region 120. In particular, printer structure 410 moves print head 420 to a specific location in display region 120 where print head 420, and directs print head 420 to print specific information at this location in response to a control signal received by printer structure 410, such as the control signal generated by logic unit 131.

In an embodiment, printer structure 410 utilizes multiple print heads to print information at different locations. Consider the example where mobile carrier 210 has two or more display regions, which are each located on a different side of mobile carrier 210. Printer structure 410 aligns a different print head with each of these display regions. Moreover, these print heads are directed to simultaneously print information in the various display regions such that the printing process becomes quicker.

With reference still to FIG. 4, print head 420 is suspended from printer structure 410 by a print head guide 430. Print head 420 is moveably coupled with print head guide 430 such that print head 420 is able to move in vertical directions 440 with respect to print head guide 430. Consider the example where print head 420 is coupled with print head guide 430 by means of a motor driven rack assembly. An electric motor is used to generate a mechanical force that moves print head 420 along a track in the rack assembly.

Moreover, print head guide 430 is moveably coupled with printer structure 410 such that print head guide 430, and consequently print head 420, is able to move about display region 120 in horizontal directions 450. In one example, a second rack assembly is housed in printer structure 410. A portion of print head guide 430 is coupled with an electric motor assembly in the second rack assembly such that print head guide 430 is moved in horizontal directions 450 in response to mechanical forces generated by the electric motor assembly. Furthermore, electric motor assembly generates these mechanical forces as a result of a substance of the generated control signal.

In an embodiment, a straddle carrier configuration is implemented during the advertisement printing process. For example, cargo containers are carried in port facilities using a straddle carrier, which is a piece of equipment that straddles the cargo containers. A lifting region is positioned at each of the top four corners of each of the various cargo containers. For example, a mechanical appendage is attached to each of the top four corners of a cargo container, and these mechanical appendages include holes through which pinions of the straddle carrier are configured to fit. Therefore, the straddle carrier includes a four-pinion substructure for coupling with the lifting regions of the cargo containers. Moreover, multiple print heads are coupled with the straddle carrier, such that print heads are aligned with different sides of a cargo container when the straddle carrier is attached to the container. In particular, the alignment of the pinion substructure with the lifting regions of the container enable the print heads to be effectively aligned with different display regions on different sides of the container such that the print heads are able to efficiently print information in these display regions.

Thus, pursuant to various embodiments, one or more print heads are used to print information in one or more display regions on a mobile advertising device, wherein these print heads move relative to the mobile advertising device. For example, with reference again to printing system 400 shown in FIG. 4, print head 420 moves in both vertical directions 440 and horizontal directions 450 with respect to display region 120.

In an alternative embodiment, however, print heads are configured to move about a printable surface in a first direction while the printable surface moves past the print heads in a second direction that is different than the first direction. Consider the example where multiple print heads are employed to print data on opposite sides of a cargo container. The print heads are able to move vertically, but do not move horizontally. Rather, the cargo container sits on a conveyer bed, which moves the container past the print heads in a horizontal direction. In this manner, a printing apparatus is able to remain stationary while printing surface move past the apparatus. Moreover, the conveyor bed is configured to move the container past the printing apparatus such that print heads used by the printing apparatus are sufficiently aligned with different sides of the container such that these print heads are able to simultaneously print information on each of these sides.

### Methods of Operation

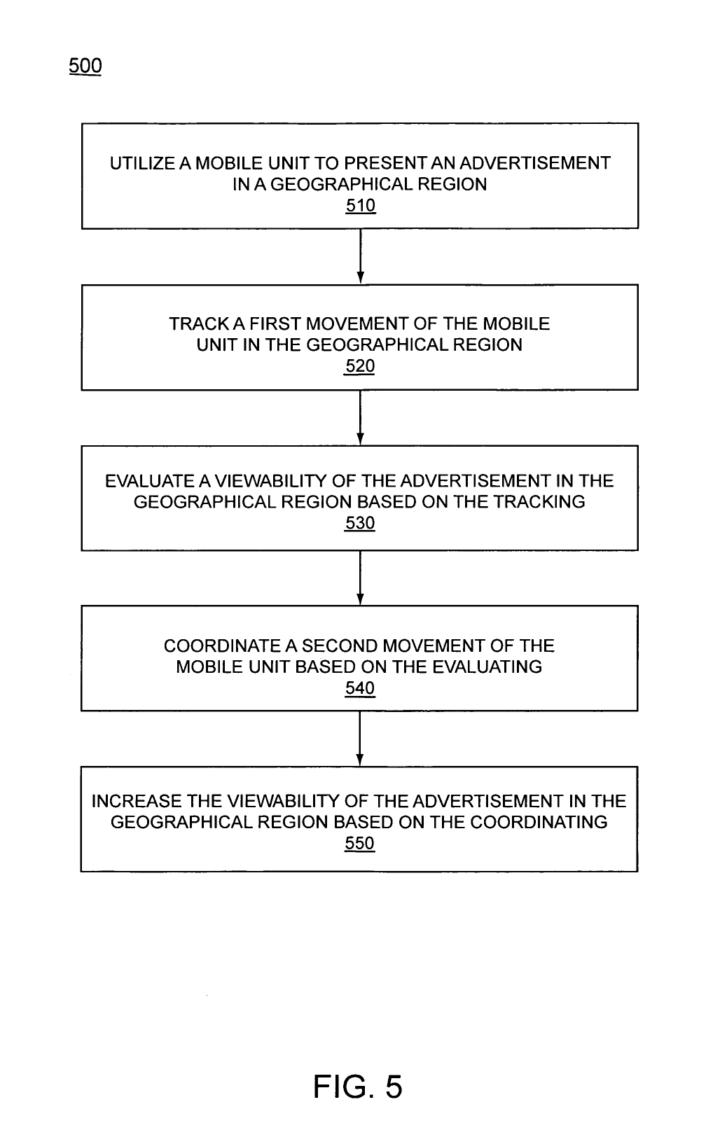

With reference now to FIG. 5, a first exemplary method 500 of targeted advertising in accordance with an embodiment is shown. First exemplary method 500 includes utilizing a mobile unit to present an advertisement in a geographical region 510, tracking a first movement of the mobile unit in the geographical region 520, evaluating a viewability of the advertisement in the geographical region based on the tracking 530, coordinating a second movement of the mobile unit based on the evaluating 540, and increasing the viewability of the advertisement in the geographical region based on the coordinating 550.

As stated above, first exemplary method 500 includes utilizing a mobile unit to present an advertisement in a geographical region 510. Consider the example where an industrial-sized cargo container is utilized to transport goods to various vendors of the goods in a geographic region. Advertisements are affixed to an outside portion of the container such that the advertisements are viewable to a population of the geographical region, depending on a present position of the mobile container as the container moves throughout the region. Indeed, in an embodiment, these advertisements are strategically placed such that these advertisements are viewable during both a transit of the container as well as when the container remains static, such as when the container reaches a destination and is being unloaded for a period of time.

First exemplary method 500 further includes tracking a movement of the mobile unit in the geographical region 520. For example, real-time position coordinates of the mobile unit are determined using a position determination device. These real-time position coordinates are then used to calculate the movement of the mobile unit in the region.

In an embodiment, the mobile unit is tracked using GPS technology. Consider the example where a shipping container is used as a mobile advertising unit. A GPS position determination device is affixed to the container, and this position determination device utilizes global positioning to determine the containers present location in a region of interest. In addition, the position coordinates determined by the position determination device are output to a wireless transmitter or transceiver, which wirelessly transmits the coordinates to a tracking station used to remotely track a present position of the container in the geographical region.

In one embodiment, the tracking station also records various movements of the mobile unit within the region based on the received position coordinates such that an actual route of the mobile unit may be remotely analyzed. For example, position, time and velocity data are determined, and this data is utilized to determine whether a present trajectory or course of the mobile unit should be altered.

First exemplary method 500 further includes evaluating a viewability of the advertisement in the geographical region based on the tracking 530. With reference again to the previous example, a present position of the shipping container is tracked using the obtained real-time position coordinates. Moreover, information associated with the section of the geographical region in which the shipping container is presently traveling is stored in a relational database. This information may include, for example, traffic patterns associated with the particular geographical area of interest. An intelligence engine is used to access this data and estimate how many people in the broader geographical region are able to presently view the advertisement displayed on the shipping container based on these traffic patterns.

Furthermore, first exemplary method 500 involves coordinating another movement of the mobile unit based on the evaluating 540, and increasing the viewability of the advertisement in the geographical region based on this coordinating 550. With reference again to the previous example, the shipping container is identified as being located in a specific section of a geographical region characterized as having a relatively low amount of human traffic. Consequently, the shipping container is re-routed to a different section of the geographical region having a greater amount of traffic so that more people will be able to se the advertisement.

In one implementation, a method of real-time programming is used to select a route based on a set of real-time factors. Such real-time factors may include, for example, a maximum real-time engineered exposure associated with the geographic region or the advertisement presented therein by the mobile unit, or a set of emerging opportunities in the region.

Moreover, in an embodiment, first exemplary method 500 includes checking whether the mobile unit follows a selected route by determining real-time position coordinates of the mobile unit by using a position determination device. The position determination device may include, for example, a GPS receiver, a GLONASS receiver, a GALILEO receiver, a GNSS receiver, or a pseudolite receiver. If it is determined that the mobile unit has deviated from a selected route, the mobile unit is directed to adjust its present course based on a positional control directive.

In an embodiment, first exemplary method 500 further includes identifying an event of interest in the geographical region, and dynamically changing a route of the mobile unit in the geographical region in response to the event of interest. Consider the example where the mobile unit is traveling through a sparsely populated region, and an earthquake causes debris to enter into the path of the mobile unit such that the path is temporarily blocked. If the mobile unit remains stationary for a period of time while the debris is being removed, the viewability of the advertisement will suffer because few people will be around to see the advertisement. Therefore, the mobile unit is dynamically re-routed to a different path so as to avoid this obstacle.

In one embodiment, first exemplary method 500 further involves generating an advertising revenue based on the viewability, and increasing the advertising revenue based on the increasing of the viewability. For example, the number of people who are able to presently view the mobile advertisement is estimated based on a present position of the advertisement in a geographical area as well as an estimated degree of human traffic in the area. A trademark of a company is displayed by the advertisement, and this company is charged an advertising fee by the operator of the mobile unit based on the assessed viewability of the advertisement. Further, in so much as the obtained advertising revenue is a function of the viewability factor, increasing the viewability of the advertisement enables the operator of the mobile unit to increase the advertising fee that is charged to the company.

In an example, a revenue stream associated with the presentation of the advertisement in the geographical region is estimated. The results of this estimated revenue stream provide the basis for an advertising fee, or price quote thereof. This revenue stream may be based on various factors, such as the substance of a pre-arrangement agreement between a mobile carrier provider and an advertisement agency, a poll conducted among a population of the geographic region, as well as a model of the revenue stream based on the demographics of the geographic region and exposure of the advertisement therein.

In an embodiment, first exemplary method 500 further involves estimating an effectiveness of the advertisement on a human population of the geographical region, and dynamically changing the advertisement in response to the effectiveness. For example, demographics associated with a population of a geographical area through which the mobile unit is presently traveling are accessed, and the advertisement displayed by the mobile unit is changed or updated based on these demographics such that the appeal of the advertised product of service to the people of the region is increased. In this manner, the effectiveness of the advertising campaign is increased. Moreover, an embodiment provides that the duration of time that a particular advertisement is presented by the mobile unit, such as before a first advertisement is replaced with a second advertisement, is monitored and recorded such that a company associated with the goods or services advertised by the advertisement is charged a fee based on this temporal period.

In one embodiment, first exemplary method 500 further includes estimating a revenue stream originating from sales in the geographical region, wherein the sales pertain to an advertised matter in the advertisement, and dynamically changing the advertisement in response to the revenue stream. For example, the mobile unit travels through a first region while displaying a first advertisement, which is used to advertise a first good or service. This first advertisement is selected based on a knowledge that the first good or service is popular among a significant cross-section of the population of the first region. However, the mobile unit subsequently travels to a second region wherein the first good or service is significantly less popular. In response, a second good or service is identified as having a greater appeal to a significant cross-section of the population of the second region. Moreover, a second advertisement is identified as advertising the second good or service. The first advertisement is then replaced with the second advertisement such that the mobile unit is utilized for advertising a more popular good or service in the second region.

In one example, the mobile unit is a mobile carrier that transports cargo in the geographical region, and the advertisement presented by the mobile carrier is selected based on the advertisement advertising a subject matter associated with the cargo. For example, a load of garlic is transported using a truck, wherein garlic is viewable through the sides of the truck used for supporting the garlic. Moreover, a sign is affixed to a side of the truck, wherein the side is used to advertise the garlic. In this manner, the cargo is simultaneously transported and advertised.

Furthermore, an embodiment provides that the advertisement is selected based on the advertisement being indicative of a vendor of a subject matter associated with the cargo. Therefore, while the cargo is being both transported and advertised, an entity willing to sell the cargo to the public is simultaneously identified, which increases the chances of the entity selling this cargo in the geographical region in which the mobile unit is traveling.

Similarly, in one embodiment, a method of product destination advertising is employed, wherein the destination of a transported product is advertised. For example, a shipping container is used to transport a product to a supermarket, and both the product and the supermarket to which the product is being transported are advertised from a viewable region of the shipping container.

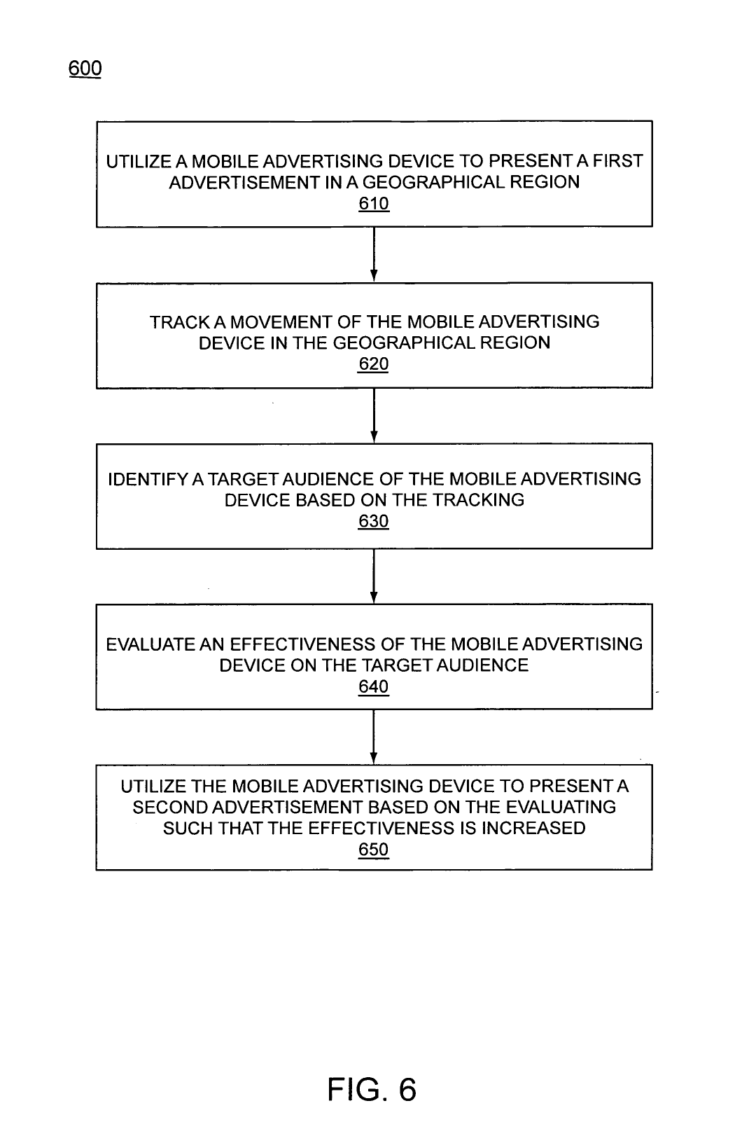

With reference now to FIG. 6, a second exemplary method 600 of targeted advertising in accordance with an embodiment is shown. Second exemplary method 600 includes utilizing a mobile advertising device to present a first advertisement in a geographical region 610, tracking a movement of the mobile advertising device in the geographical region 620, identifying a target audience of the mobile advertising device based on the tracking 630, evaluating an effectiveness of the mobile advertising device on the target audience 640, and utilizing the mobile advertising device to present a second advertisement based on the evaluating such that the effectiveness is increased 650.

In an embodiment, second exemplary method 600 further includes generating an advertising revenue based on the effectiveness of the mobile advertising device, and increasing the advertising revenue in response to the effectiveness of the mobile advertising device being increased. For example, a first context associated with the first advertisement is identified, and the effectiveness of the mobile advertising device is estimated based on this first context. The effectiveness is evaluated as being relatively low, due to the unappealing nature of the first context to a population in the geographical region.

In an embodiment, a context associated with an advertisement is evaluated, based on a criterion associated with a majority of members of the target audience. This criterion may be selected, for example, from a group of criteria consisting of religion, language, ethnicity, age, income, gender, ownership status, marital status, fertility, mortality, mobility and migration. In an alternative embodiment, the first context is evaluated based on a criterion associated with the geographical region within which the mobile unit presents the advertisement. This criterion may be selected, for example, from a group of criteria consisting of weather, season, time of day, country, population, traffic patterns and consumer statistics associated with the geographical region.

Moreover, an embodiment provides that a second context is identified as being different than the first context, and the second advertisement is selected based on the second advertisement being associated with the second context. Consider the example where the effectiveness of the mobile advertising device is estimated to be relatively low, due to the unappealing nature of the first context. A second context is identified as being relatively popular among the people of the region of interest, and this more popular context provides a basis for presenting the second advertisement in the region rather than the first advertisement.

To further illustrate, an example provides that the mobile advertising device is traveling in a country wherein the population is predominantly Muslim. Moreover, this predominantly Islamic nation has recently been engaging in a military conflict with a nation that is predominantly Jewish or Christian. As a result of this conflict, advertisements with Jewish or Christian scenes, slogans or symbols are unappealing to a major cross-section of the population of the Islamic nation. Therefore, when the mobile advertising device travels through this nation, an advertisement having a context that may be reasonably construed as promoting the Jewish or Christian religions is no longer presented using the mobile advertising device. Furthermore, the removed advertisement is replaced with an advertisement having a context that is more attractive to the population of the Islamic nation, such as an advertisement used to advertise goods associated with an Islamic holiday.

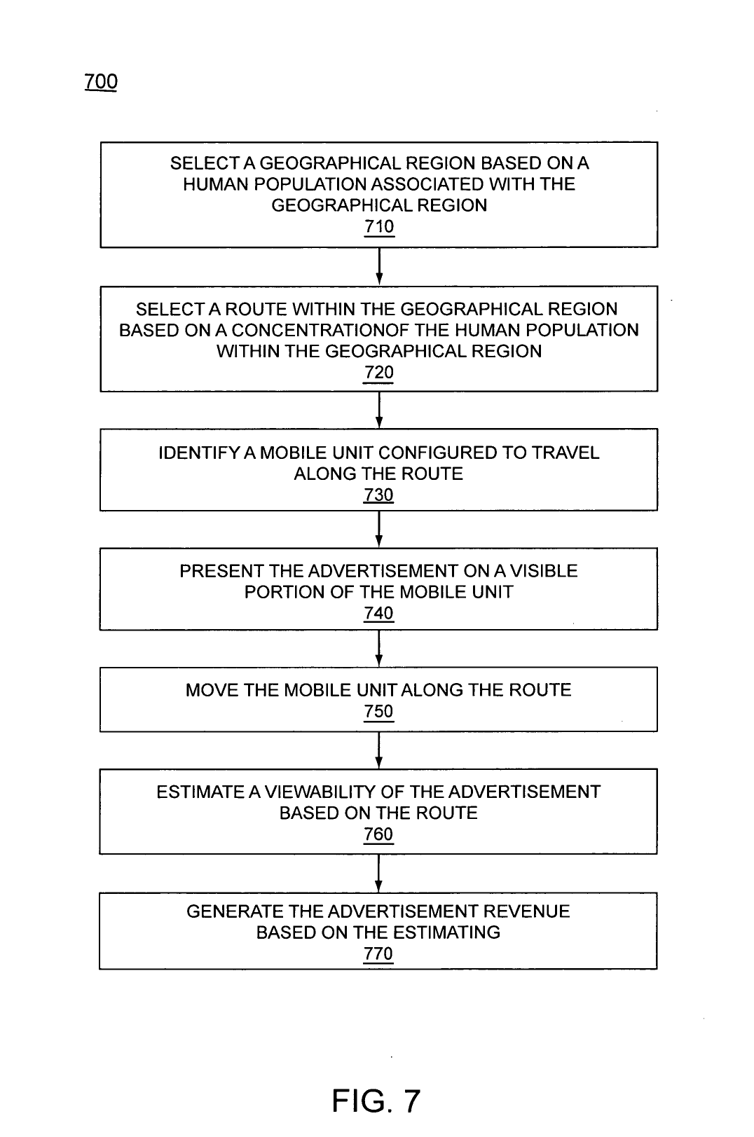

With reference now to FIG. 7, an exemplary method 700 of generating advertising revenue in accordance with an embodiment is shown. Method 700 includes selecting a geographical region based on a human population associated with the geographical region 710, selecting a route within the geographical region based on a concentration of the human population within the geographical region 720, identifying a mobile unit configured to travel along the route 730, presenting the advertisement on a visible portion of the mobile unit 740, moving the mobile unit along the route 750, estimating a viewabilty of the advertisement based on the route 760, and generating the advertisement revenue based on the estimating 770.

To illustrate, an example provides that a particular geographical region is identified as being an area of interest due to a dense human population in the region. Moreover, human traffic patterns in the region are analyzed in order to identify routes through the region characterized as having more human traffic. These routes are characterized as being more valuable to a potential advertisement provider based on this significant degree of human traffic, and one of these routes is selected based on its potential to increase an effectiveness of a particular advertisement on the population in the region.

Pursuant to one embodiment, various mobile advertising units travel along various routes in a geographical region, and the advertising space on a particular mobile advertising unit is priced pursuant to the value of the route along which the mobile unit travels. However, in one embodiment, an auctioning method is employed, wherein specific advertising space, or entire routes, is auctioned off to various bidders. Consider the example where an advertisement provider identifies a route of interest. The advertisement provider may bid on the route such that a mobile advertising unit traveling along this route displays advertisements provided by the advertisement provider, and such that the advertisement provider has the right to exclude the use of such advertising space along such route by other entities.

In an embodiment, method 700 further includes estimating an effectiveness of the advertisement in the TGR. Moreover, the advertisement is changed based on the estimating of the effectiveness. The viewability of the advertisement is increased based on the changing of the advertisement, and as a result, the advertisement revenue is increased based on the increased viewability of the advertisement.

Pursuant to one embodiment, however, method 700 includes estimating an effectiveness of the advertisement in the TGR, and adjusting the route along which the mobile unit travels based on the estimating of the effectiveness. Adjusting this route causes the viewability of the advertisement to be increased, and the advertisement revenue is increased as a result of this increased viewability.

In an embodiment, the mobile unit is configured to display multiple advertisements simultaneously. For example, the mobile unit includes multiple advertising spaces, wherein each advertising space may be acquired by an advertisement provider. The advertisement provider pays a fee for the use of an advertising space based on the location of the advertising space on the mobile unit.

To further illustrate, a mobile unit travels along a road in a geographic region, and the advertising spaces on the mobile unit are priced based on the eye level of an average driver along this road. Advertising spaces that align with a relaxed eye level of the average driver are priced higher than advertising spaces that are not aligned with this eye level. In this manner, an advertisement is cheaper when placed at a location on the mobile unit such drivers must strain themselves in order to view the content of the advertisement. In contrast, when advertisements located at a “prime height” on the mobile unit such that the drivers may easily view the content of these advertisements based on the natural eye level of the drivers, the cost associated with the advertising space utilized by these advertisements is more expensive.

Although various electric, mechanical and electrochemical systems are discussed herein, these systems are presented as exemplary implementations, and are not intended to suggest any limitation as to the scope of use or functionality of the present technology. Neither should such systems be interpreted as having any dependency or relation to any one or combination of components illustrated in the disclosed examples.

Moreover, one or more operations of various embodiments of the present technology may be controlled or implemented using computer-executable instructions, such as program modules, being executed by a computer. Generally, program modules include routines, programs, objects, components, data structures, etc., that perform particular tasks or implement particular abstract data types. In addition, the present technology may also be practiced in distributed computing environments where tasks are performed by remote processing devices that are linked through a communications network. In a distributed computing environment, program modules may be located in both local and remote computer-storage media including memory-storage devices.

### Example Computer System Environment

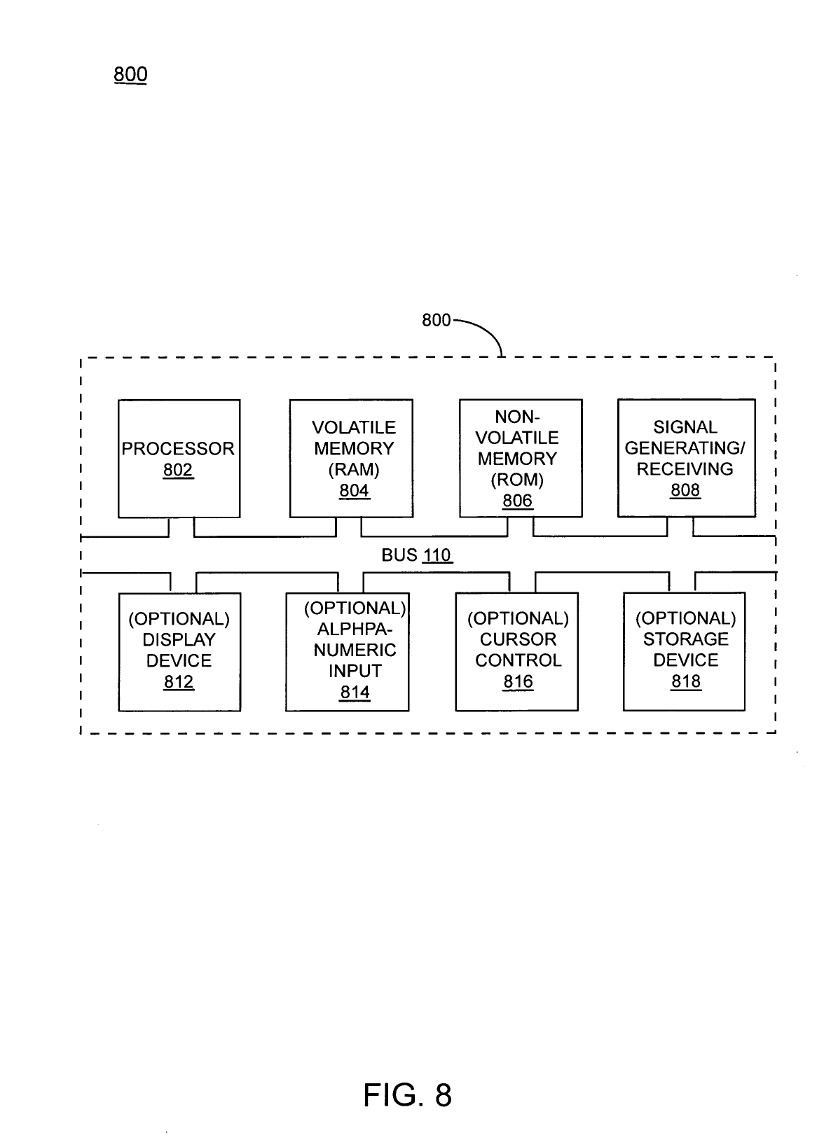

With reference now to FIG. 8, a block diagram of an exemplary computer system 800 in accordance with an embodiment is shown. Computer system 800 of the present embodiment may be well suited to be any type of computing device (e.g., a computing device utilized to perform calculations, processes, operations, and functions associated with a program or algorithm). Within the discussions herein, certain processes and steps are discussed that are realized, in one embodiment, as a series of instructions (e.g., software program) that reside within computer readable memory units and are executed by one or more processors of computer system 800. When executed, the instructions cause computer system 800 to perform specific actions and exhibit specific behavior that may be described in detail herein.

Computer system 800 includes an address/data bus 810 for communicating information, one or more central processors, such as central processor 802, are coupled with bus 810. Central processor 802 is used to processing information and instructions. Moreover, central processor 802 may be a microprocessor or any other type of processor. Computer system 800 also includes data storage features such as a computer usable volatile memory unit 804 (e.g., random access memory, static RAM, dynamic RAM, etc.) coupled with bus 810 for storing information and instructions for central processor 802, and a computer usable non-volatile memory unit 806 (e.g., read only memory, programmable ROM, flash memory, EPROM, EEPROM, etc.) coupled with bus 810 for storing static information and instructions for central processor 802. Computer system 800 also includes one or more signal generating and receiving devices 808 coupled with bus 810 for enabling computer system 800 to interface with other electronic devices and computer systems. The communication interface(s) implemented by one or more signal generating and receiving devices 808 may include wired (e.g., serial cables, modems, and network adaptors) and/or wireless (e.g., wireless modems and wireless network adaptors) communication technology.

Optionally, computer system 800 may include an alphanumeric input device 114 including alphanumeric and function keys coupled to the bus 810 for communicating information and command selections to central processor 802. Computer system 800 can include an optional cursor control or cursor-directing device 816 coupled to bus 810 for communicating user input information and command selections to central processor 802. Cursor-directing device 816 may be implemented using a number of well-known devices such as a mouse, a track-ball, a track-pad, an optical tracking device, and a touch screen, among others. Alternatively, it is appreciated that a cursor may be directed and/or activated via input from alphanumeric input device 814 using special keys and key sequence commands. The present embodiment is also well suited to directing a cursor by other means such as, for example, voice commands.

Computer system 800 of FIG. 8 may also include one or more optional computer usable data storage devices 818 such as a magnetic or optical disk and disk drive (e.g., hard drive, floppy diskette, Compact Disk-Read Only Memory (CD-ROM), Digital Versatile Disk (DVD)) coupled with bus 810 for storing information and/or computer executable instructions. An optional display device 812 may be coupled to bus 810 of computer system 800 for displaying video and/or graphics. It should be appreciated that optional display device 812 may be a cathode ray tube (CRT), flat panel liquid crystal display (LCD), field emission display (FED), plasma display or any other display device suitable for displaying video and/or graphic images and alphanumeric characters recognizable to a user.

Computer system 800 is presented herein as an exemplary computing environment in accordance with an embodiment. However, computer system 800 is not strictly limited to being a computer system. For example, an embodiment provides that computer system 800 represents a type of data processing analysis that may be used in accordance with various embodiments described herein. Moreover, other computing systems may also be implemented. Indeed, the spirit and scope of the present technology is not limited to any single data processing environment.

Moreover, although the subject matter has been described in a language specific to structural features and/or methodological acts in various embodiments herein, the subject matter defined in the appended claims is not necessarily limited to the specific features or acts described above. Rather, the specific features and acts described above are disclosed as example forms of implementing the claims.

What is claimed is:

1. A system for displaying a mobile advertisement, said system comprising:
a mobile carrier for transporting cargo in a geographical region;
a control signal receiver coupled with said mobile carrier, said control signal receiver receiving a control signal used to communicate data related to said mobile advertisement; and
a display panel coupled with said mobile carrier, said display panel displaying said mobile advertisement in said geographical region based on said control signal.

2. The system of claim 1, further comprising:
a rack assembly coupled with said mobile carrier; and
a printer head moveably coupled with said rack assembly, said printer head moving about said rack assembly and printing said advertisement on said display panel in response to said control signal.

3. The system of claim 1 wherein said display panel is an electronic display panel configured to update said advertisement in response to a change in said control signal.

4. The system of claim 1 wherein said mobile carrier has a first corrugated surface, and wherein said display panel has a second corrugated surface configured to couple with said first corrugated surface.

5. The system of claim 1 wherein said control signal receiver is a wireless transceiver for wirelessly receiving said control signal.

6. The system of claim 5, further comprising:
a position determination device that obtains real time position coordinates of said mobile carrier and wirelessly transmits said real-time position coordinates to a tracking station.

7. A method of targeted advertising, said method comprising:
utilizing a mobile unit to present an advertisement in a geographical region;
tracking a first movement of said mobile unit in said geographical region;
evaluating a viewability of said advertisement in said geographical region based on said tracking;
coordinating a second movement of said mobile unit based on said evaluating; and
increasing said viewability of said advertisement in said geographical region based on said coordinating.

8. The method of claim 7, further comprising:
determining real-time position coordinates of said mobile unit using a position determination device; and
calculating said first movement of said mobile unit using said real-time position coordinates.

9. The method of claim 7, further comprising:
generating an advertising revenue based on said viewability; and
increasing said advertising revenue based on said increasing of said viewability.

10. The method of claim 7, further comprising:
identifying an event of interest in said geographical region; and
dynamically changing a route of said mobile unit in said geographical region in response to said event of interest.

11. The method of claim 7, further comprising:
estimating an effectiveness of said advertisement on a human population of said geographical region; and
dynamically changing said advertisement in response to said effectiveness.

12. The method of claim 7, further comprising:
estimating a revenue stream originating from sales in said geographical region, said sales pertaining to an advertised matter in said advertisement; and
dynamically changing said advertisement in response to said revenue stream.

13. The method of claim 7 wherein said utilizing said mobile unit to present said advertisement in said geographical region further comprises:
utilizing said mobile unit to present said advertisement in said geographical region, said mobile unit being a mobile carrier that transports cargo in said geographical region.

14. The method of claim 13, further comprising:
selecting said advertisement based on said advertisement advertising a subject matter associated with said cargo.

15. The method of claim 13, further comprising:
selecting said advertisement based on said advertisement being indicative of a vendor of a subject matter associated with said cargo.

16. A method of targeted advertising, said method comprising:
utilizing a mobile advertising device to present a first advertisement in a geographical region;
tracking a movement of said mobile advertising device in said geographical region;
identifying a target audience of said mobile advertising device based on said tracking;
evaluating an effectiveness of said mobile advertising device on said target audience; and
utilizing said mobile advertising device to present a second advertisement based on said evaluating such that said effectiveness is increased.

17. The method of claim 16, further comprising:
generating an advertising revenue based on said effectiveness; and
increasing said advertising revenue in response to said effectiveness being increased.

18. The method of claim 17, further comprising:
identifying a first context associated with said first advertisement; and
estimating said effectiveness based on said first context.

19. The method of claim 17, further comprising:
evaluating said first context based on a criterion associated with a majority of members of said target audience, said criterion being selected from a group of criteria consisting of religion, language, ethnicity, age, income, gender, ownership status, marital status, fertility, mortality, mobility and migration.

20. The method of claim 17, further comprising:
evaluating said first context based on a criterion associated with said geographical region, said criterion being selected from a group of criteria consisting of weather, season, time of day, country, population, traffic patterns and consumer statistics.

21. The method of claim 17, further comprising:
identifying a second context that is different than said first context; and
selecting said second advertisement based on said second advertisement being associated with said second context.

22. A method of generating advertisement revenue, said method comprising:
selecting a geographical region based on a human population associated with said geographical region;
selecting a route within said geographical region based on a concentration of said human population within said geographical region;
identifying a mobile unit configured to travel along said route;
presenting said advertisement on a visible portion of said mobile unit;
moving said mobile unit along said route;
estimating a viewabilty of said advertisement based on said route; and
generating said advertisement revenue based on said estimating.

23. The method of claim 22, further comprising:
estimating an effectiveness of said advertisement in said TGR.

24. The method of claim 23, further comprising:
changing said advertisement based on said estimating of said effectiveness;
increasing said viewability based on said changing; and
increasing said advertisement revenue based on said increased viewability.

25. The method of claim 23, further comprising:
adjusting said route based on said estimating of said effectiveness;
increasing said viewability based on said adjusting; and
increasing said advertisement revenue based on said increasing of said viewability.
